(19) United States
(12) Patent Application Publication
(10) Pub. No.: US 2003/0177235 A1
(43) Pub. Date: Sep. 18, 2003

(54) Electrical network for data transmission

(75) Inventor: Gert Grammel, Uhingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/384,668

(22) Filed: Mar. 11, 2003

(30) Foreign Application Priority Data
Mar. 13, 2002 (EP) 02 360 085.1

(51) Int. Cl. G06F 15/173

(52) U.S. Cl. 709/225; 709/224

(57) ABSTRACT

A network for data transmission is described. In the network, data is fed to the network via a first connection (S-N1) and fed through the network via a second connection (N1-N2). In the network, the first connection (S-N1) has a first transmission capacity and the second connection (N1-N2) has a second transmission capacity, the first transmission capacity being greater than the second transmission capacity. Means are provided for determining a criterion for a so-called QoS (quality of service) of the network depending on the duration (P2, P3) of pauses per time unit during transmission of data via the first connection (S-N1).

The invention is based on a priority application EP 02 360 085.1 which is hereby incoporated by reference.

### FIELD OF THE INVENTION

The invention relates to the field of telecommunications and more particularly to a method of determining a criterion for a so-called QoS (quality of service) of a network for data transmission, in which data is fed to the network via a first connection and fed through the network via a second connection, and in which the first connection has a first transmission capacity and the second connection has a second transmission capacity, the first transmission capacity being greater than the second transmission capacity. The invention also concerns an appropriate electrical network for data transmission.

### BACKGROUND OF THE INVENTION

The QoS (quality of service) of a network is usually understood to mean its reliability, availability or error frequency. This QoS must be determined in some way for a network to be assessed.

For instance, a known criterion which is used for the QoS of a network is the number of data items which are lost during transmission via the network.

However, the operator of a network often guarantees that no data is lost during transmission. For this purpose, it is possible to limit the flow of data to an input of the network. This results in delays of data transmission via the network. In this case, a criterion for the QoS of the network can be, for instance, the delay of data during transmission via the network.

The charges for use of the network are often defined on the basis of this QoS of the network, however it is determined. It is thus possible that the operator of the network guarantees a specified QoS, for instance fault-free transmission of data with a maximum delay. For this guaranteed QoS, the user of the network pays a specified basic charge. However, if this QoS is temporarily not achieved by the network, e.g. because of errors in the network, the operator of the network pays compensation for this reduced QoS. This can be, for instance, an at least partial repayment of the basic charge, or another kind of credit to the user of the network.

### SUMMARY OF THE INVENTION

The object of the invention is to create a method, which is as simple as possible for the operator of the network to carry out and is understandable for the user of the network, of determining a criterion for such a QoS.

The way in which this object is achieved according to the invention in the case of a method of the above-mentioned type is that the criterion for the QoS of the network is determined depending on the duration of pauses per time unit during transmission of data via the first connection. In the case of a network of the above-mentioned type, the object is achieved accordingly according to the invention.

The duration of pauses per time unit during transmission of data via the first connection can very easily be captured by the operator of the network. For instance, it is possible for the operator to measure this pause duration at the relevant input of the network. The longer the pause duration is, the less data is transmitted via the network, and the lower is the QoS of the network. If the QoS becomes lower than, for instance, the QoS which the operator guarantees, the above-mentioned compensation must be paid by the operator to the user of the network.

For the user of the network, the pause duration is an understandable measurement for the QoS of the network. At least in extreme cases, the user can even appreciate this pause duration by the transmission duration of the user's data. Additionally, it is acceptable for the user that compensation can only be expected if when data is transmitted via the network it is, for instance, delayed beyond the guaranteed QoS.

In an advantageous extension of the invention, the second transmission capacity is a maximum transmission capacity of the second connection, the associated QoS of which is guaranteed by the operator of the network to the users of it. In the case of this second maximum transmission capacity, the associated duration of pauses per time unit is preferably calculated as follows: P2=(1−RN/RS)×T, where RN=maximum transmission capacity of connection N1-N2, RS=maximum transmission capacity of connection S-N1, T=time unit.

In another advantageous extension of the invention, the second transmission capacity is a reduced transmission capacity of the second connection, the associated QoS of which is less than the guaranteed QoS. In the case of this second reduced transmission capacity, the associated duration of pauses per time unit is preferably measured.

In an advantageous form of the invention, if the lower QoS is present, compensation is paid by the operator of the network to the user of the network. The compensation preferably depends on the measured duration of pauses per time unit or on the difference between the measured duration and the calculated duration.

It is specially advantageous if the duration of pauses per time unit is determined between successive packets. The pauses therefore only occur between two successive packets of the transmitted data. It is also specially advantageous if the duration of pauses per time unit is averaged. In this way the relationship to a time unit can be levelled out.

Other features, possible uses and advantages of the invention are given in the following description of the embodiments of the invention which are shown in the figures. All features which are described or shown form the subject of the invention, in themselves or in any combination, irrespective of how they are summarised in the claims, or their backward reference, and irrespective of their formulation or representation in the description or figures respectively.

### BRIEF DESCRIPTION OF THE DRAWINGS

FIG. 1 shows a schematic block diagram of an embodiment of an electrical network for data transmission according to the invention, and

FIG. 2 shows two schematic timing diagrams of data transmission via the network of FIG. 1.

### DETAILED DESCRIPTION OF THE INVENTION

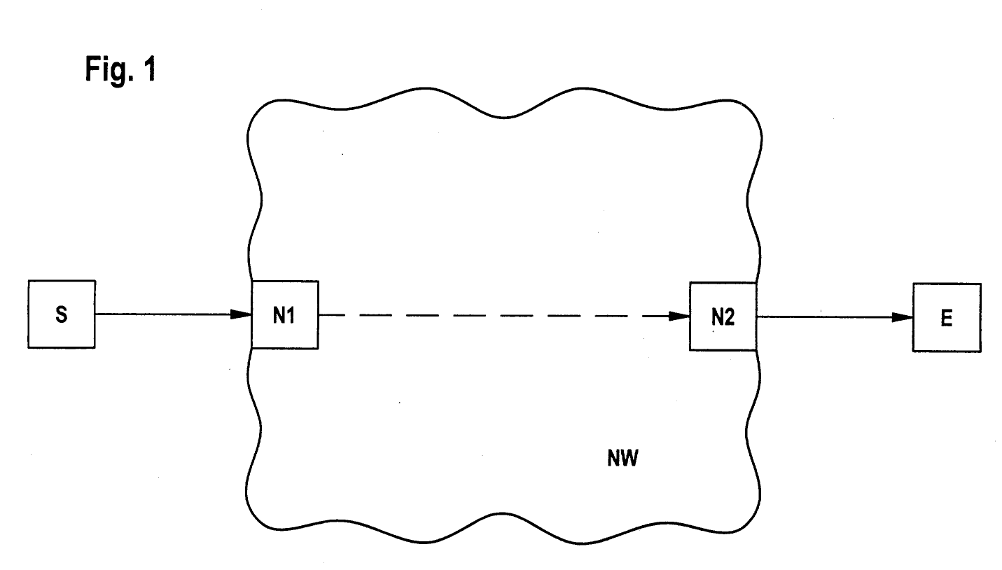

In FIG. 1, an electrical network NW for data transmission is shown, for instance the Internet. The network NW is provided to transmit data from a transmitter S to a receiver E. For this purpose, the data is first transmitted from the transmitter S to an input N1 of the network NW, then within the network NW from the input N1 to an output N2, and finally from the output N2 of the network NW to the receiver E.

Data is transmitted from the transmitter S to the receiver E, and in particular within the network NW, in the form of packets.

The network NW has a maximum transmission capacity for transmission of packets from the input N1 to the output N2. If the network NW reaches this maximum transmission capacity, mechanisms are present to limit the flow of further packets via the input N1 into the network NW per time unit. Exceeding the maximum transmission capacity of the network NW, and associated malfunctions, are thus avoided. In this way, the network NW guarantees that between the input N1 and the output N2, and thus within the network NW, no packets are lost.

These mechanisms are based quite generally on the input N1, depending on how full its data buffer is, requesting the transmitter S to insert a pause in data transmission. The transmitter S only transmits new data to the input N1 after this pause has expired. The duration of the pause is thus known to both this input N1 and the transmitter S.

For instance, it is possible that the transmitter S wants to transmit three packets without a pause. The input N1 receives the first packet and immediately transmits it onward. The input N1 receives the second packet, but has to store it temporarily, because it is still transmitting the second packet. The above-mentioned mechanisms can now consist of the input N1 sending a pause request to the transmitter S, to prevent an overflow of its data buffer and thus a data loss occurring. The transmitter S then waits for the pause duration. Meanwhile, the input N1 completes the passing on of the first and second packets. The transmitter S now transmits the third packet, which is then received and immediately passed on by the input N1.

In a first case, the connection from the transmitter S to the input N1 has less transmission capacity than the connection from the input N1 to the output N2, or at most the same. Below, the first connection is called connection S-N1 and the second connection is called connection N1-N2. In this case, the mechanisms to limit the flow of packets into the network NW are not themselves necessary.

On the other hand, in a second case the connection S-N1 has a greater transmission capacity than the connection N1-N2. This means that the connection N1-N2 can be a bottleneck for transmission of packets from the transmitter S to the receiver E. In this case, the described mechanisms intervene.

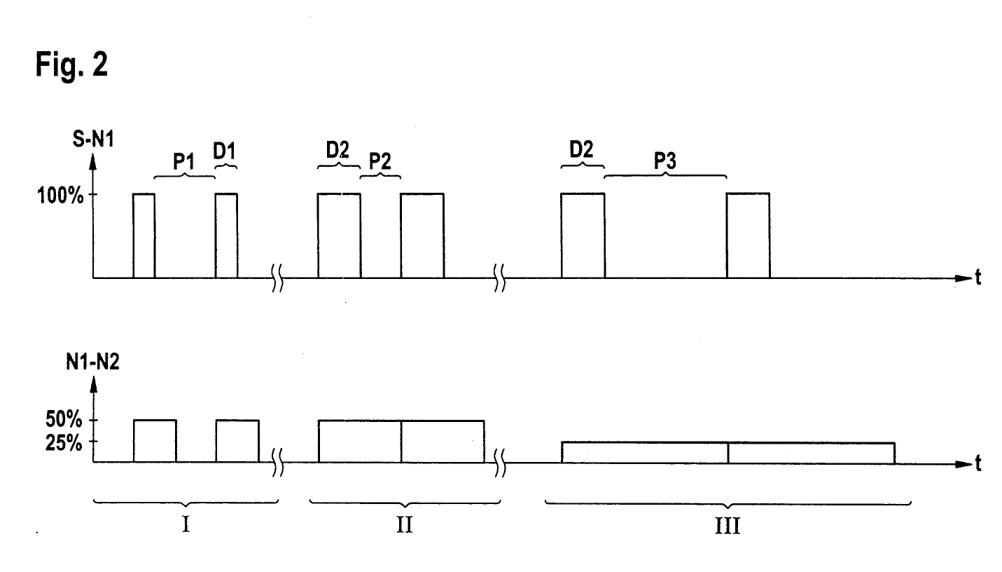

In FIG. 2, transmission of packets via the connection S-N1 and connection N1-N2 are plotted over time t. The transmission capacity of the connection S-N1 is 100%, whereas the transmission capacity of the connection N1-N2 is only 50%. Consequently, the same transmission via the connection N1-N2 takes exactly twice as long as via the connection S-N1.

In an area I of FIG. 2, two successive transmissions of packets via the connections S-N1 and N1-N2 are shown. Each of the two transmissions via the connection S-N1 has a duration D1. Between these two transmissions via the connection S-N1, there is a pause of duration P1. The pause is a consequence of the described mechanisms.

The duration P1 of the pause is greater in the area I than the duration D1 of the first transmission via the connection S-N1. The double transmission duration which is required for this first transmission on the connection N1-N2 thus does not extend over the duration P1 of the above-mentioned pause.

In an area II of FIG. 2, two more successive transmissions of packets via the connections S-N1 and N1-N2 are shown. Each of the two transmissions via the connection S-N1 has a duration D2. Between these two transmissions via the connection S-N1, there is a pause of duration P2. The pause is again a consequence of the described mechanisms.

In area II, the duration P2 of the pause corresponds to the duration D2 of the first transmission via the connection S-N1. The double transmission duration which is required for this first transmission on the connection N1-N2 thus extends exactly until the end of the duration P2 of the above-mentioned pause. Area II thus represents a limiting case for transmission of packets from the transmitter S to the output N2.

As soon as more packets per time unit are to be transmitted via the connection S-N1, which would be possible in itself because of the greater transmission capacity of the connection S-N1, the above-mentioned mechanisms for limiting the flow of packets into the input N1 of the network NW intervene again. This means that the number of transmitted packets via the connection S-N1 is affected in such a way that the limiting case described above for transmission of packets from the transmitter S to the output N2 is never exceeded.

For this limiting case, the following applies generally:

D2=RN/RS×T

P2=(1−RN/RS)×T

where

RN=maximum transmission capacity of connection N1-N2

RS=maximum transmission capacity of connection S-NI

T=time unit

The maximum transmission capacities RN and RS are known. The time unit T can be specified. In this way the duration P2 of the pauses between transmissions via the connection S-N1 can be calculated for the described limiting case.

This calculated duration P2 of the pauses per time unit T for the above-mentioned limiting case is guaranteed as a criterion for a so-called QoS (=quality of service) of the network NW. This means that the operator of the network NW guarantees to every user of the network NW that the user's data is transmitted via the network NW while conforming to this criterion, i.e. that maximum pauses with duration P2 per time unit T occur during transmission of the user's data.

In operation of the described network NW, the duration P2 of the pauses per time unit T can be measured in the input N1 and/or in the transmitter S. As has been described, the input N1 requests the pauses at the transmitter S. The transmitter S can therefore log the pause requests and thus capture the pauses per time unit T.

As long as there is no error within the network NW, the measured duration P2 of the pauses per time unit T is never greater than the calculated duration P2. This means that the above-mentioned guaranteed QoS of the network NW is achieved.

However, if there is an error within the network NW, the consequence is that the maximum transmission capacity of the connection N1-N2 becomes less.

This is shown in area III of FIG. 2. The transmission capacity of the connection N1-N2 has fallen to 25% compared to the transmission capacity of the connection S-N1.

In area III of FIG. 2, two other successive transmissions of packets via the connections S-N1 and N1-N2 are shown. Each of the two transmissions via the connection S-N1 has a duration D2. Between these two transmissions via the connection S-N1, there is a pause with a duration P3. The pause is a consequence of the described mechanisms.

The first transmission via the connection S-N1, which requires the duration D2 there, requires four times the duration via the connection N1-N2. If the next transmission via the connection S-N1 were to take place after a pause with duration P2, as described in area II for the limiting case, it would not be possible to transmit these packets onward immediately via the connection N1-N2. This would result in loss of packets. For this reason, in this case—as stated—the described mechanisms to limit the flow of packets into the input NI intervene.

The result of the above-mentioned mechanisms is that in area III, between the two transmissions via the connection S-N1, a longer pause with duration P3 is present. The duration P3 is three times as great as the duration D2 of the first transmission via the connection S-N1. This duration P3 of the pause of area III, which is significantly longer than the duration P2 of area II, represents the above-mentioned limitation of the flow of packets into the input N1.

The result of the described pause with duration P3 in area III is that the transmission capacity via the connection N1-N2, which is reduced compared to area II, does not cause any data losses. Instead, the transmission of further packets via the connection S-N1 waits—for exactly the duration P3—until the connection N1-N2 is again capable of further transmission.

For the described error case, the following applies generally:

D3=RN′/RS×T

P3=(1−RN′/RS)×T

where

RN′=reduced transmission capacity of connection N1-N2

RN′=a×RN

a=reduction factor

0<a <1

The reduced transmission capacity RN′ of the connection N1-N2 results from the error within the network NW and is unknown.

However, the duration P3 of the pauses per time unit T at the input N1 and/or of the transmitter S can be measured in the described error case. This measured duration P3 for the error case of area III is greater than the calculated duration P2 for the limiting case of area II.

The measured duration P3 for the pauses per time unit T in the error case of area III is now considered to be the criterion for the QoS of the network NW. Since—as stated—the duration P3 is longer than the duration P2, on the basis of this difference it is possible to deduce the extent of the reduction of the conformity of this criterion.

The operator of the network NW can then pay compensation for the reduced QoS to the user of the network NW, depending on the duration P3 and/or depending on the difference between the duration P3 and the duration P2.

This can be calculated on the basis of the following equation:

P3−P2=(1−a)×RN/RS×T

If the measured duration P3 of the error case and the calculated duration P2 of the limiting case are put into this equation, the only remaining unknown quantity is the factor a for the reduction of the transmission capacity via the connection N1-N2. This factor a can thus be calculated. Depending on this factor a, the operator of the network NW can then pay the above-mentioned compensation to the user.

1. A method of determining a criterion for a quality of service of a network for data transmission, in which data is fed to the network via a first connection and fed through the network via a second connection, and in which the first connection has a first transmission capacity and the second connection has a second transmission capacity, the first transmission capacity being greater than the second transmission capacity, the method comprises the steps of determining pauses per time unit (T) during transmission of data via the first connection (S-N1) and determining the criterion for the quality of service of the network (NW) depending on the duration (P2, P3) of said pauses.

2. A method according to claim 1, wherein the second transmission capacity is a maximum transmission capacity of the second connection, the associated QoS of which is guaranteed by the operator of the network to the users of it.

3. A method according to claim 2, wherein in the case of the second maximum transmission capacity the duration of pauses per time unit is calculated as follows: P2=(1−RN/RS)×T, where RN=maximum transmission capacity of connection N1-N2, RS=maximum transmission capacity of connection S-N1, T=time unit.

4. A method according to claim 2, wherein the second transmission capacity is a reduced transmission capacity of the second connection, the associated QoS of which is less than the guaranteed QoS.

5. A method according to claim 4, wherein in the case of the second reduced transmission capacity, the duration of pauses per time unit is measured.

6. A method according to claim 4, wherein the operator of the network pays compensation to the user of the network if the lower QoS is present.

7. A method according to claims 5, wherein the compensation depends on the measured duration of pauses per time unit(.

8. A method according to claim 7, wherein the compensation depends on the difference between the measured duration and the calculated duration.

9. A method according to claim 1, wherein the duration of pauses per time unit is averaged.

10. A method according to claim 1, wherein the duration of pauses per time unit is determined between successive packets.

11. A network for data transmission, in which data is fed to the network via a first connection and fed through the network via a second connection, and in which the first connection has a first transmission capacity and the second connection has a second transmission capacity, the first transmission capacity being greater than the second transmission capacity, wherein means are provided for determining a criterion for a so-called QoS of the network depending on the duration of pauses per time unit during transmission of data via the first connection.
